(19) United States
(12) Patent Application Publication
(10) Pub. No.: US 2006/0187607 A1
(43) Pub. Date: Aug. 24, 2006

(54) Apparatus and method for creating pulse magnetic stimulation having modulation function

(76) Inventor: Seung-Kee Mo, Seoul (KR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/551,418

(22) PCT Filed: May 27, 2003
(86) PCT No.: PCT/KR03/01034

§ 371 Date: Sep. 30, 2005

(30) Foreign Application Priority Data
Mar. 31, 2003 (KR) 10-2003-0020084

(51) Int. Cl. H01H 47/00

(52) U.S. Cl. 361/143

(57) ABSTRACT

An apparatus for creating pulse magnetic stimulation, having a modulation function, according to the present invention, comprises: a driving voltage supplying section for converting AC voltage input from a voltage source into DC voltage having a predetermined magnitude; a capacitor section for accumulating electric charge in accordance with the DC voltage; an input switch section for controlling the accumulation of electric charge in the capacitor section; a coil for generating magnetic flux in accordance with current generated by both-end voltage corresponding to the electric charge accumulated in the capacitor section; an output switch section for controlling discharge of the electric charge accumulated in the capacitor section through the coil; and a shunt switch section for lowering magnetic energy stored in the coil and voltage stored in the capacitor section into a ground level to obtain a pulse magnetic field. In this pulse-magnetic-stimulation creating apparatus having a modulation function according to the present invention, it is possible to efficiently transfer energy on the basis of current compliance of a patient and impedance of biologic tissue for therapeutic applications.

### BACKGROUND OF THE INVENTION

1. Field of the Invention

The present invention relates to an apparatus and method for creating pulse magnetic stimulation with a modulation function, and specifically to an apparatus and method for creating pulse magnetic stimulation with a modulation function, capable of non-invasively stimulating a human body such as nerves, muscles, bones, blood vessels, etc. for therapeutic applications using a high-speed external time-varying magnetic field.

2. Description of the Related Art

The electromagnetic induction law, in which electricity can be converted into magnetism or magnetism can be converted into electricity, has been widely used in power generators, transformers or the like. In addition, methods of medical treatment using such electromagnetic induction law have been developed continuously, and in recent, the electromagnetic induction law has been widely used up to neuromuscular treatments.

In general, stimulation methods for treating a neuromuscular system of a human body can be classified into an electrical stimulation method and a magnetic stimulation method.

The electrical stimulation method is a method in which stimulation is created by attaching pessary-shaped electrodes or patch-shaped electrodes to a human body and then allowing current to flow therein. On the other hand, the magnetic stimulation method is a method in which stimulation is created by inducing magnetic energy into a skin or a body system to generate eddy current, the magnetic energy being generated by discharging electric energy stored in a capacitor to a magnet coil for generating an external time-varying magnetic field.

Basically, the principle of generating magnetic stimulation falls within a range of Faraday's Law of electromagnetic induction in which when flux Φ linking with a circuit varies, an electromotive force e proportional to a ratio at which the flux is decreased is induced into the circuit. A direction of the induced current flowing in the circuit due to the electromagnetic induction is against variation in linkage flux of the circuit in accordance with Lentz's Law.

Such electromagnetic induction law is used in a variety of types for the therapeutic purposes of a human body, and hereinafter a case that the electromagnetic induction law applies to an apparatus for treating urinary incontinence as one type will be described with reference to FIG. 1.

FIG. 1 is a block diagram illustrating a conventional apparatus for treating urinary incontinence.

Referring to FIG. 1, a drive circuit of the conventional apparatus for treating urinary incontinence comprises a power supply and charging section 10, a transferring section 20, a discharging section 30 and a stimulation coil 40.

The power supply and charging section 10 performs a function of boosting an input voltage into a high voltage.

The transferring section 20 comprises switching elements SCR1, SCR2, a pumping inductor L1, a current control inductor L2 and a transfer capacitor C1 to transfer the voltage supplied from the power supply and charging section 10.

The discharging section 30 performs a function of storing and discharging the voltage supplied from the transferring section 20, and current flows in the stimulation coil 40 due to discharge of the discharging section 30.

In the drive circuit of this conventional apparatus for treating urinary incontinence, a voltage from a high-voltage generating section (not shown) is stored in a charging capacitor (not shown) of the power supply and charging section 10, and when the switching element SCR1 of the transferring section 20 is switched on, the charge accumulated in the charging capacitor of the power supply and charging section 10 is accumulated the transfer capacitor C1 of the transferring section 20 through the pumping inductor L1. Then, when the switching element SCR2 is switched on, the charge accumulated in the transfer capacitor C1 is supplied to the discharging section 30 through the current control inductor L2. By repeating such processes multiple times, the necessary electric charge is supplied from the transferring section 20 to a discharging capacitor C2 of the discharging section 30. The discharging capacitor C2 of the discharging section 30 keeps accumulating the charge from the transferring section 20, and when a discharging switch SCR3 is switched on, the discharging capacitor C2 discharges the charge at one time. Then, current flows in the stimulation coil 40 due to the discharged charge.

However, the drive circuit of the conventional apparatus for treating urinary incontinence has some drawbacks in that i) very high voltage exceeding a dielectric strength of a general switch is generated at both ends of the switch in discharging, ii) the unreasonable transferring section 20 is provided, iii) the system is complicated due to the addition of the transferring section 20, iv) production cost is additionally increased, and v) operation sequences thereof are complicated. Further, the conventional apparatus is disadvantages in that the inductance of the stimulation coil 40 is not considered.

A variety of related arts exist in addition to the aforementioned conventional art, but since a human body is not a conductive coil as a necessary condition for accomplishing the therapeutic purpose of body stimulation according to the conventional art, only a simple construction of electromagnetic induction apparatus cannot accomplish the therapeutic purpose.

The conventional art has additional problems that an optimal system for obtaining a desired induced voltage cannot only be constructed, but also characteristics of switch circuits are not considered.

### SUMMARY OF THE INVENTION

Accordingly, it is an object of the present invention to provide an apparatus and method for creating pulse magnetic stimulation with a modulation function, in which it is possible to efficiently transfer energy on the basis of current compliance of a patient and impedance of a biologic tissue.

It is a further object of the present invention to provide an apparatus and method for creating pulse magnetic stimulation with a modulation function, in which separate means for storage into a high voltage or various auxiliary means such as a pumping coil or a current restriction coil are not required as necessary elements when a magnetic stimulation apparatus is used for the purpose of medical treatment.

It is a further object of the present invention to provide an apparatus and method for creating pulse magnetic stimulation with a modulation function, in which various modulation methods such as ramp modulation, phase modulation, duration modulation, timing modulation, amplitude modulation, frequency modulation and duty modulation may be performed.

Additional object of the present invention is to provide a magnetic flux emitting unit which is a mobile type, not a fixed type, and which is incorporated into one body with or attachable to a magnetic flux focusing unit for focusing magnetic flux generated from a coil.

In order to accomplish the above objects, according to one aspect of the present invention, an apparatus for creating pulse magnetic stimulation, in which pulse current is generated to create magnetic flux, is provided, the apparatus comprising: a driving voltage supplying section for receiving AC voltage from a voltage source, converting the received AC voltage into DC voltage having a predetermined magnitude, and then outputting the DC voltage; a capacitor section for accumulating electric charge in accordance with the DC voltage; an input switch section provided between the driving voltage supplying section and the capacitor section, for controlling the accumulation of electric charge in the capacitor section; a coil connected in series to the capacitor section, for generating magnetic flux in accordance with current generated by both-end voltage corresponding to the electric charge accumulated in the capacitor section; an output switch section provided between the capacitor section and the coil, for controlling discharge of the electric charge accumulated in the capacitor section through the coil; and a shunt switch section connected in parallel between the coil and the output switch section, for lowering magnetic energy stored in the coil and voltage stored in the capacitor section into a ground level to obtain a pulse magnetic field.

The driving voltage supplying section may comprise: a variable regulator for converting the AC voltage supplied from the voltage source into an AC voltage specified by a control section; a transformer for boosting the AC voltage outputted from the variable regulator into an AC voltage having a magnitude corresponding to a predetermined transformation ratio; and a rectifying section for converting the AC voltage boosted by the transformer into the DC voltage. In addition, the variable regulator can adjust a magnitude of the output AC voltage.

The driving voltage supplying section may further comprise a filtering section for smoothing the DC voltage full-wave rectified by the rectifying section.

Furthermore, in the apparatus for creating pulse magnetic stimulation according to the present invention, when the magnetic energy and the voltage are lowered into the ground level in a state that the shunt switch section is switched on, the output switch section may be switched off.

Furthermore, in the apparatus for creating pulse magnetic stimulation according to the present invention, when the electric charge has been completely accumulated in the capacitor section, the input switch section may be switched off and the output switch section may be switched on. In addition, it is determined by means of capacitance of the capacitor section whether the electric charge has been completely accumulated in the capacitor section or not.

The apparatus for creating pulse magnetic stimulation according to the present invention may further comprise a power monitoring section for calculating a magnitude of the current using the magnetic flux generated due to the current flowing through the coil to detect an error of a large power signal.

The capacitor section of the apparatus for creating pulse magnetic stimulation according to the present invention may be connected in parallel to an additional capacitor group, the additional capacitor group may comprise one or more additional capacitor sections connected in parallel, respectively, and each of the additional capacitor sections may comprise one additional capacitor and one switching element connected in series.

On or off state of the switching element of the additional capacitor section may be controlled to change a value of capacitance, and only when the switching element is switched on, the capacitor section and the additional capacitor section may be connected in parallel one another.

Furthermore, in the apparatus for creating pulse magnetic stimulation according to the present invention, when the input switch section and the shunt switch section are switched off and the output switch section is switched on, the capacitor section and the coil may constitute an RLC serial resonant circuit, and each parameter value of the RLC serial resonant circuit may satisfy an under-damping condition.

Furthermore, the output switch section of the apparatus for creating pulse magnetic stimulation according to the present invention is switched on and off every one or a half period of the RLC serial resonant circuit, and a period in which the output switch section is switched on and off may be preferably set to be less than 1 khz and normally set to be less than 300 Hz.

A waveform of the pulse current may be at least one of a sine wave, a square wave and a triangle wave.

Furthermore, the input switch section, the output switch section and the shunt switch section of the apparatus for creating pulse magnetic stimulation according to the present invention may be any one of a relay, a thyristor and an Insulated Gate Bipolar Transistor (IGBT).

According to another preferred embodiment of the present invention, an apparatus for creating pulse magnetic stimulation, in which pulse current is generated to create magnetic flux, the apparatus having a resonant circuit comprising a coil, a resistor and a capacitor, is provided, the apparatus further comprising: a driving voltage supplying section connected in parallel to the capacitor, for accumulating electric charge in the capacitor, by receiving AC voltage from a voltage source, converting the received AC voltage into DC voltage having a predetermined magnitude, and then outputting the DC voltage; an input switch section provided between the driving voltage supplying section and the capacitor, for allowing the electric charge to be accumulated in the capacitor only when the input switch section is switched on; an output switch section provided between the capacitor and the coil, for allowing the electric charge accumulated in the capacitor to be discharged through the coil only when the output switch section is switched on; and a shunt switch section connected in parallel between the coil and the output switch section, for lowering magnetic energy stored in the coil and voltage stored in the capacitor into a ground level to obtain a pulse magnetic field.

In addition, the driving voltage supplying section may comprise: a variable regulator for converting the AC voltage supplied from the voltage source into an AC voltage specified by a control section; a transformer for boosting the AC voltage output from the variable regulator into an AC voltage having a magnitude corresponding to a predetermined transformation ratio; and a rectifying section for converting the AC voltage boosted by the transformer into the DC voltage.

The capacitor may be connected in parallel to an additional capacitor group, the additional capacitor group may comprise one or more additional capacitor sections connected in parallel, respectively, and each of the additional capacitor sections may comprise one additional capacitor and one switching element connected in series.

According to another aspect of the present invention, a method of supplying a pulse current to generate magnetic stimulation is provided, the method comprising: a step of inputting an operation start instruction to an apparatus for creating pulse magnetic stimulation; (a) a step in which a power supplying section receives an AC voltage from a voltage source and converts the received AC voltage into an output AC voltage having a predetermined magnitude; (b) a step in which a rectifying section converts the converted AC voltage into a DC voltage; (c) a step in which when an input switch section is switched on, a capacitor section accumulates electric charge corresponding to the DC voltage; (d) a step of switching off the input switch section and switching on an output switch section, when the capacitor section has completely accumulated the electric charge; (e) a step of allowing a current to flow in a coil, the current being generated due to a both-end voltage corresponding to the electric charge accumulated in the capacitor section; (f) a step in which the coil generates magnetic flux on the basis of the current; (g) a step of switching on a shunt switch section after a predetermined period time; (h) a step of switching off the output switch section and switching on the input switch section, when magnetic energy stored in the coil and voltage accumulated in the capacitor section is lowered into a ground level; and a step of repeating the steps (a) to (h) until an operation end instruction is input to the apparatus for creating pulse magnetic stimulation, or a predetermined burst on period expires. In addition, a system, an apparatus and a recording medium for enabling the above method of supplying a pulse current to be executed are provided.

The method of supplying a pulse current according to the present invention may further comprise a step of determining a magnitude of voltage to be stored in the capacitor section after carrying out the steps (a) to (h). In addition, the magnitude of voltage to be stored in the capacitor section may be determined on the basis of a magnitude of an output AC voltage converted by a variable regulator of the power supplying section.

Furthermore, the steps (a) to (d) may be carried out in a pulse off state where a current does not flow in the coil, and the steps (e) to (h) may be carried out in a pulse on state where a current flows in the coil.

Furthermore, the burst on period is a period that the pulse on state and the pulse off state are alternately repeated and thus an induced voltage is generated to create a stimulation, and the burst on period may comprise a stimulation ramp-up period, a stimulation maintenance period and a stimulation ramp-down period.

During the stimulation ramp-up period, a magnitude of the output AC voltage converted by the variable regulator of the power supplying section becomes higher gradually, during the stimulation maintenance period, the magnitude of the output AC voltage of the power supplying section is maintained constantly, and during the stimulation ramp-down period, the magnitude of the output AC voltage converted by the variable regulator of the power supplying unit becomes lower gradually.

The apparatus for creating pulse magnetic stimulation according to the present invention can vary a modulation period corresponding to a period of the pulse on time and the pulse off time with varying the pulse off time.

Furthermore, the apparatus for creating pulse magnetic stimulation according to the present invention may include at least one of a ramp modulation, a phase modulation, a duration modulation, a timing modulation, an amplitude modulation, a frequency modulation and a duty modulation.

Furthermore, the apparatus for creating pulse magnetic stimulation may include at least one chosen from a ramp modulation, a phase modulation, a duration modulation, a timing modulation, an amplitude modulation, a frequency modulation and a duty modulation.

According to another preferred embodiment of the present invention, a magnetic flux emitting unit for externally emitting magnetic flux generated from a coil in a stimulation apparatus having a resonant circuit comprising the coil, a resistor and a capacitor, the apparatus generating a pulse current to create the magnetic flux, is provided, the unit comprising: the coil; a case having an insulating feature and also having a disk shape surrounding the coil; a grip projected from a lower portion of the case; and a lead line coupled to the coil and penetrating through the case and the grip.

The coil of the magnetic flux emitting unit may be formed to be a single-layer solenoid shape, and the case may have a plurality of air holes for cooling heat generated from the coil in an air cooling manner.

Furthermore, a magnetic flux focusing unit for focusing the magnetic flux generated from the coil on one point using a boundary condition of magnetic field may be coupled to the case of the magnetic flux emitting unit, and a coolant and a stratiform iron core of the magnetic flux focusing unit may be sealed.

In this case, the stratiform iron core of the magnetic flux focusing unit is disposed in parallel to the coil, the permeability of materials of the central stratiform iron core is larger than the permeability of material of the peripheral stratiform iron core, an end portion of the stratiform iron core from which the magnetic flux is emitted is formed to have a toy top shape, and the coolant is circulated through a hose connected to the magnetic flux focusing unit.

### BRIEF DESCRIPTION OF THE DRAWINGS

The aforementioned aspects and other features of the present invention will be explained in the following description, taken in conjunction with the accompanying drawings, wherein:

FIG. 1 is a block diagram illustrating a drive circuit of a conventional apparatus for treating urinary incontinence;

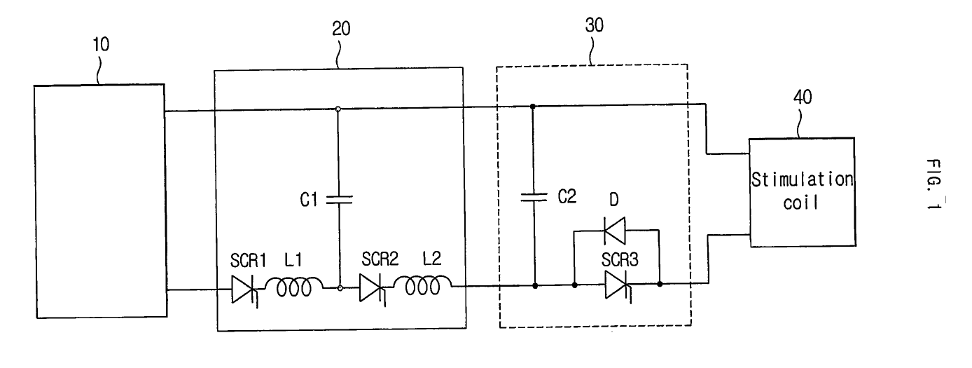

FIG. 2A is a block diagram of an apparatus for creating pulse magnetic stimulation according to one preferred embodiment of the present invention;

FIG. 2B shows an external appearance of the apparatus for creating pulse magnetic stimulation according to the one preferred embodiment of the present invention;

FIG. 3 is a circuit diagram illustrating a detailed configuration of an RLC serial resonant circuit of the apparatus for creating pulse magnetic stimulation according to the one preferred embodiment of the present invention;

FIG. 4A is a view illustrating an example of a magnet coil according to the one referred embodiment of the present invention;

FIG. 4B is a view illustrating a principle of focusing magnetic flux;

FIG. 4C is a view exemplifying a configuration of a probe of the apparatus for creating pulse magnetic stimulation according to the one preferred embodiment of the present invention;

FIG. 5 is a view exemplifying a method of coupling an output monitor according to the one preferred embodiment of the present invention;

FIG. 6A is a circuit diagram illustrating in detail the apparatus for creating pulse magnetic stimulation according to the one preferred embodiment of the present invention;

FIG. 6B is a view illustrating an output modulation characteristic of the apparatus for creating pulse magnetic stimulation according to the one preferred embodiment of the present invention;

FIG. 7A is a block diagram of an apparatus for creating pulse magnetic stimulation according to another preferred embodiment of the present invention; and

FIG. 7B is a circuit diagram illustrating in detail a square wave generating circuit according to the another preferred embodiment of the present invention.

(Reference Numerals)
105: driving voltage supplying section
110: voltage input section
120: high-voltage transformer
130: rectifier
140: filtering section
145: input switch
150: pulse capacitor
155: output switch
160: shunt switch
170: magnet coil
175: power monitor
180: control unit
185: peripheral unit
510: variable regulator
710: square wave generating circuit

### DESCRIPTION OF THE PREFERRED EMBODIMENTS

The present invention relates to a pulse-magnetic-stimulation creating apparatus having a modulation function, having a simpler circuit configuration compared to other conventional apparatuses, by connecting a shunt switch to a magnet coil L in parallel in an RLC serial resonant circuit. The apparatus for creating pulse magnetic stimulation according to the present invention stimulates nerves, muscles, bones, blood vessels of a human body to effectively inject the stimulation energy into the human body. In addition, the apparatus for creating pulse magnetic stimulation according to the present invention provides a modulation function of varying the output power, thereby providing a variant mode (in which the energy injected into a human body is varied with time) of effectively transferring energy in the course of injecting the stimulation energy.

Now, preferred embodiments of the present invention will be described in detail with reference to the appended drawings.

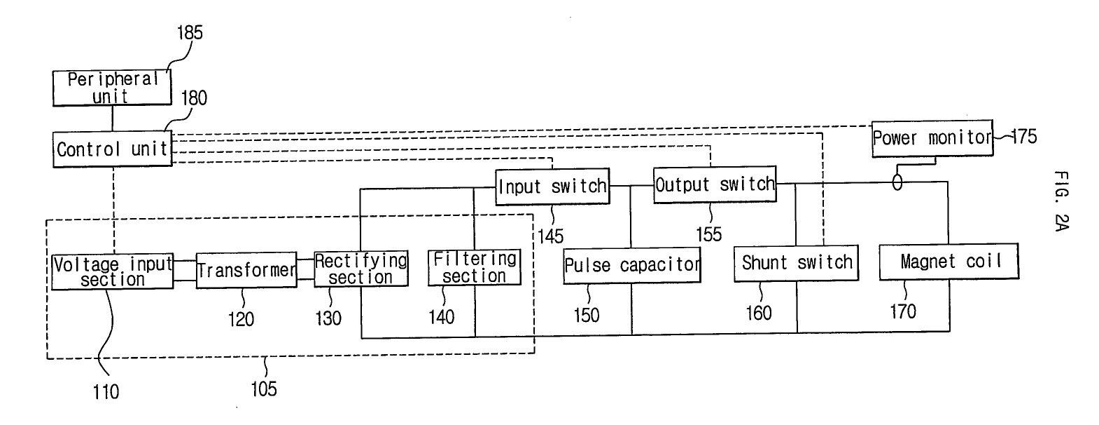

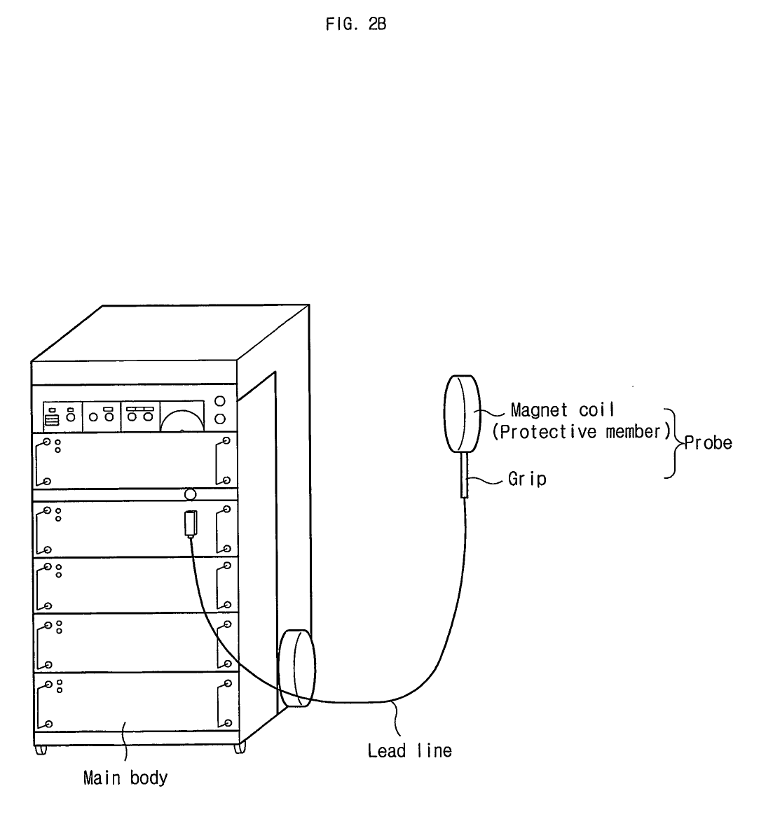

FIG. 2A is a block diagram illustrating an apparatus for creating pulse magnetic stimulation according to one preferred embodiment of the present invention, and FIG. 2B shows an external appearance of the apparatus for creating pulse magnetic stimulation according to the one preferred embodiment of the present invention.

Referring to FIG. 2A, the apparatus for creating pulse magnetic stimulation comprises a driving voltage supplying section 105, an input switch 145, a pulse capacitor 150, an output switch 155, a shunt switch 160, a magnet coil 170, a power monitor 175, a control unit 180 and a peripheral unit 185.

The driving voltage supplying section 105 comprises a voltage input section 110, a high-voltage transformer 120, a rectifier 130 and a filtering section 140.

The voltage input section 110 serves for adjusting a secondary voltage using a variable regulator. As the variable regulator included in the voltage input section 110, a variable transformer is a unit for converting input AC voltage into a desired magnitude to form a new AC power source, and may be provided in a primary side or a secondary side, but preferably in the secondary side. The variable regulator adjusts the secondary voltage in accordance with output value information set by an operator or output value information received from the control unit 180. The apparatus for creating pulse magnetic stimulation according to the present invention can continuously vary the amplitude of voltage with respect to the same pulse width using the variable transformer. A reason that the apparatus for creating pulse magnetic stimulation according to the present invention may control the amplitude of voltage prior to the primary side of the transformer 120 is to eliminate difficulties in the control of the amplitude of voltage and complication in circuits associated with extremely high level of signal posterior to the transformer 120.

The transformer 120 serves for boosting the output voltage of the voltage input section 110 into a high voltage. For example, a 3 kV level transformer of which the input and output signals are AC voltage and the output voltage to the input voltage is 200:1500[V] can be employed. A method of designing a transformer is as follows. The magnet coil 170 is first designed in accordance with an induced voltage desired by a user, and an L value of the magnet coil 170 and a desired current are established. After constituting an RLC serial resonant circuit, the pulse capacitor 150 satisfying an under-damping condition is then determined. When the pulse capacitor 150 is determined, the storage voltage thereof is calculated, and the voltage obtained by calculating the relevant storage voltage and efficiency of the rectifier 130 and adding a compensating value thereto is the output voltage of the transformer 120. Then, using the current value flowing in lines, the capacitance of the transformer can be determined.

The rectifier 130 serves for converting the high AC voltage into a high DC voltage. That is, the rectifier 130 carries out the full-wave rectification using a bridge rectifying diode to convert the AC voltage into the DC voltage.

The filtering section 140 serves for smoothing a ripple voltage, since the DC voltage full-wave-rectified by the rectifier 130 has a ripple waveform having a continuous semi-period. That is, the filtering section 140 is connected to a ground terminal (−) and a power supply terminal (+) at both ends of the bridge rectifying diode. For example, a DC smoothing capacitor serving as a low pass filter can be used.

The input switch 145 serves for accumulating electric charge in the pulse capacitor, and examples thereof include a relay, a thyristor, an Insulated Gate Bipolar Transistor (IGBT) and the like. The input switch 145 is switched on for a time period that the pulse capacitor 150 does not allow a current to flow in the magnet coil 170, and is switched off for a time period that the pulse capacitor 150 allows a current to flow in the magnet coil 170. Therefore, the input switch 145 is operated in a sequence inverse to a sequence of the following output switch 155.

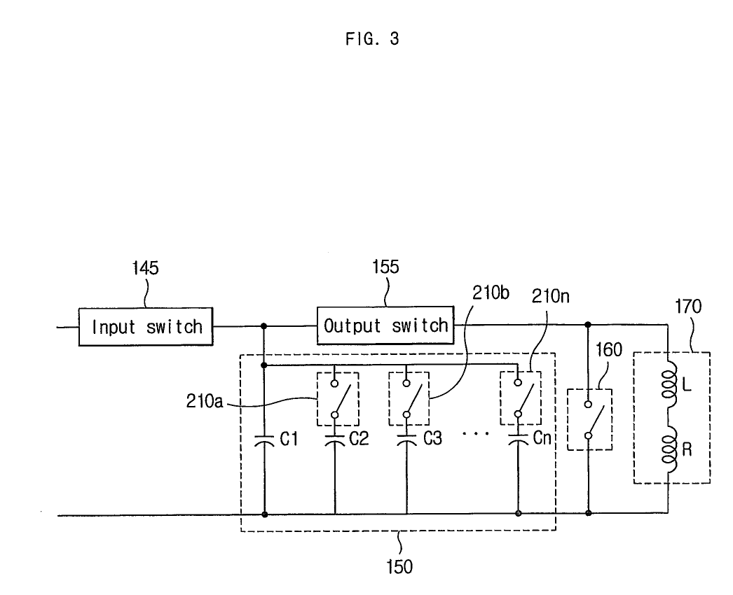

The pulse capacitor 150 serves as a capacitor in the RLC serial resonant circuit, and the pulse capacitor 150 may comprise a plurality of pulse capacitor groups connected in parallel each other (see FIG. 3).

The output switch 155 serves for discharging the electric charge accumulated in the pulse capacitor 150. The shunt switch 160 serves for obtaining a pulse magnetic field, not an alternate magnetic field. Examples of the output switch 155 and the shunt switch 160 include a relay, a thyristor, an Insulated Gate Bipolar Transistor (IGBT) and the like.

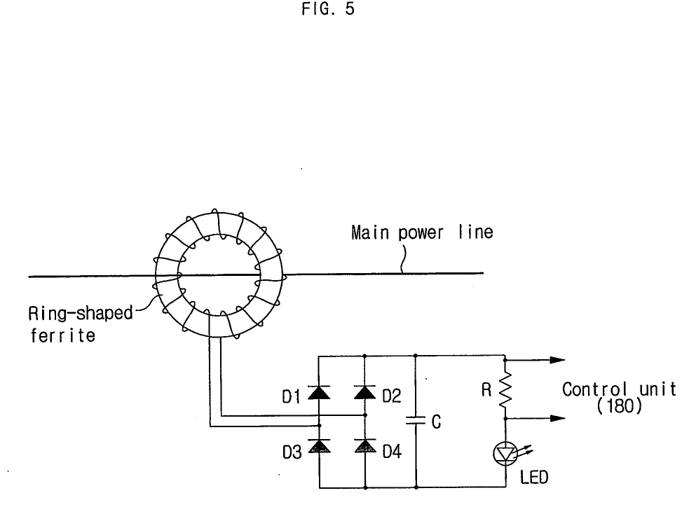

The magnet coil 170 serves for converting the electric field into the magnetic field to obtain a magnetic induced voltage. The power monitor 175 detects magnetic flux generated due to a large current flowing in lines through the magnet coil 170 and detects the current flowing in lines, thereby serving for detecting errors of the large power signals. Since the power monitor 175 uses the magnetic flux generated due to the current flowing in the lines though the magnet coil 170, the power monitor 175 can be implemented in a non-contact manner, and thus does not require a separate power source. A method of designing the power monitor will be described in detail with reference to FIG. 5.

The control unit 180 serves for controlling the input variation (for example, adjustment of variable transformer), on/off of the input switch 145, on/off of a selection switch (see FIG. 3), on/off of the shunt switch 160, acquisition of the power monitoring value, interface with peripheral units, or the like. The control unit 180 may further comprise units such as a controller, a memory, an A/D and D/A relay or the like required for driving the system, and may further comprise a power source circuit constructed independently as needed.

The peripheral units 185 may include an input unit (for example, keyboard, etc.) for inputting data, an output unit (for example, a monitor, a printer, etc.) for outputting data, a memory unit for memorizing data, or the like.

On the other hand, an external appearance of the apparatus for creating pulse magnetic stimulation is illustrated in FIG. 2B.

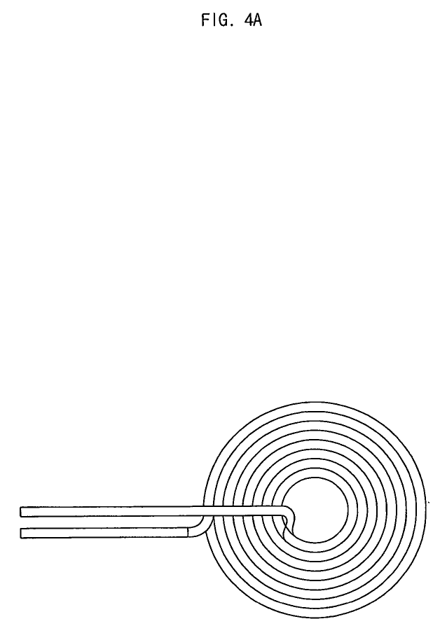

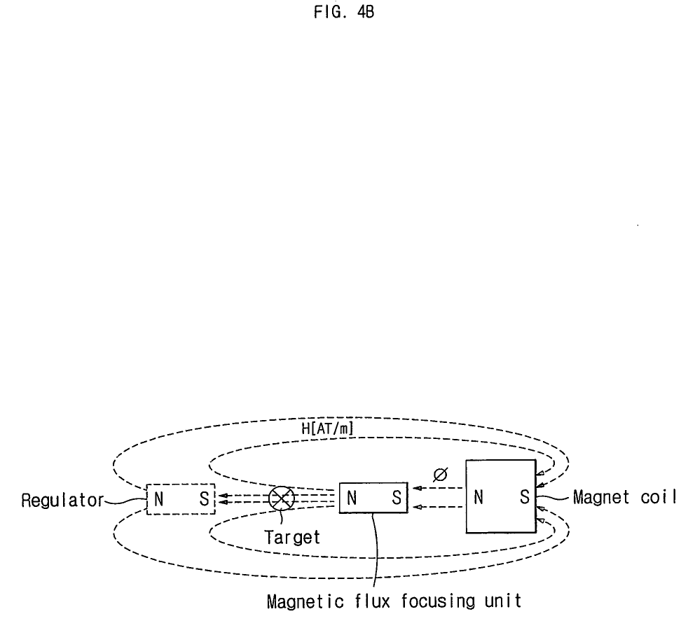

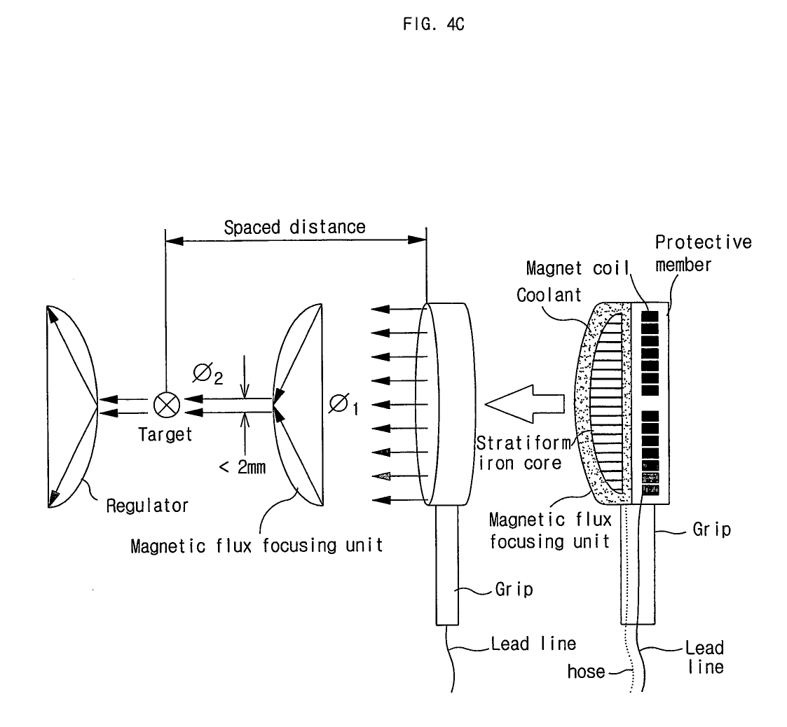

Referring to FIG. 2B, the apparatus for creating pulse magnetic stimulation according to the present invention comprises a main body, a lead line, a magnet coil 170 and a protective member (including a grip). The magnet coil 170 and the protective member are together referred to as a probe (that is, a magnetic flux emitting unit). Shapes and functions of the probe and the magnet coil 170 will be described in detail with reference to FIGS. 4A to 4C later.

The probe of the apparatus for creating pulse magnetic stimulation is manufactured in a mobile type, and the main body is manufactured in a rack shape to enable the respective modules to be exchanged. Further, the voltage induced from the external magnetic field emitted from the probe of the apparatus for creating pulse magnetic stimulation according to the present invention is set to be 5V to 15V at a point apart by 1 cm from the magnet coil 170 in the probe.

Referring to FIG. 2A again, the circuits of the apparatus for creating pulse magnetic stimulation basically comprises the RLC serial resonant circuit based on a pulse capacitor 150, the magnet coil 170 and an internal resistor R of the magnet coil 170, and may further comprises other circuits or units. In general, the RLC serial resonant circuit is a standard circuit being completely operated with a low voltage and a small current. However, in the pulse-magnetic-stimulation creating apparatus driven with a high voltage and a large current, the RLC serial resonant circuit is not operated or incompletely operated without adding a protective unit in the RLC serial resonant circuit. For example, in a state that the output switch 155 is switched off, when the input switch 145 is switched on using the rectifier 130, the electric energy is stored in the pulse capacitor 150. Thereafter, when the input switch 145 is switched off and the output switch 155 is switched on, a minus discharge current i flows through the magnet coil 170 due to the electric charge (positive voltage at both ends) accumulated in the pulse capacitor 150.

After the discharge is finished, a plus discharge current i′ inversely flows through the pulse capacitor 150 due to the magnetic energy (½ Li²) stored in the magnet coil 170, so that the electric energy at both ends of the pulse capacitor 150 is stored in minus inversely to the initial state.

By adjusting values of circuit elements R, L and C, three damping conditions can occur in the RLC serial resonant circuit: an over-damping condition (for example, R=1Ω, L=10 μH, C=100 μF), a critical-damping condition (for example, R=0.632Ω, L==10 μH, C=100 μF) and an under-damping condition (for example, R=0.1Ω, L=10 μH, C=100 μF). In the above three conditions, it allows a pulse current flow in the magnet coil 170 to induce the induced voltage externally.

However, since the current flow under the under-damping condition is efficient for the purpose of therapeutic treatment, the apparatus for creating pulse magnetic stimulation according to the present invention uses values of electrical parameters satisfying the under-damping condition. This is because it is possible to naturally allow the plus and minus current flows to be symmetric and it is also possible to obtain the induced current such the sum of the plus and minus induced currents is 0 or close to 0. Furthermore, this is because additional elements and controls are required for obtaining such induced current under the over-damping condition and the critical-damping condition.

The current waveform is alternated to be damped gradually with repetition of the storage and discharge. The reason for the current damp with repetition of the storage and discharge is that some of the magnetic energy stored in the magnet coil 170 is consumed as Joule's heat due to the internal resistor R of the magnet coil 170 and other energy is discharged. Therefore, the current flowing through the magnet coil 170 due to discharge of the pulse capacitor 150 is repeatedly and periodically stored and discharged as a current under the under-damping condition with a waveform of damped oscillation sine wave.

A semi-period (in a case of single phase wave), one period (in a case of two phase wave) or desired periods (in a case of multi phase wave) is selected for such damped oscillation wave, and then the output switch 155 is switched off at an end point of the period to break off the current.

When the input switch 145 is switched on again to charge the pulse capacitor 150 and the aforementioned processes are repeated, it is possible to obtain the current waveform of the damped oscillation sine wave and to allow the set current to flow in the magnet coil 170. A period of the damped oscillation sine wave under the under-damping condition can be obtained using the well-known circuit theory formula (that is, T=2π/ωₙ).

Furthermore, when it is intended to use only one period of the damped oscillation sine wave, the output switch 155 should be switched off at an end point of one period, but burdens (for example, surge, etc.) of break-off of the high voltage and the large current together with very large opening/closing noise are imposed on the output switch 155 due to the magnetic energy stored in the magnet coil 170.

In this case, insertion of additional units such as a current restriction coil as described in the conventional art is not a fundamental measure. This is because the magnetic energy stored in the magnet coil 170 still exists even when the current restriction coil is inserted.

Although it is described in the conventional art that the magnetic energy stored in the magnet coil 170 is emitted as Joule's heat, it is not correct. The magnetic energy stored in the magnet coil 170 may be emitted as Joule's heat for a short time (for example, several μs), but most of the magnetic energy is applied to the output switch 155 when it is switched on or off.

Therefore, in order to solve the above problems, the RLC serial resonant circuit is constructed in the apparatus for creating pulse magnetic stimulation according to the present invention, by connecting the shunt switch 160 in parallel to the magnet coil 170. That is, in a state that the shunt switch 160 is switched off, when the output switch 155 is switched off and the input switch 145 is switched on, the pulse capacitor 150 is in the charged state. Thereafter, when the input switch 145 is switched off and the output switch 155 is switched on, a disstorage current i flows through the magnet coil 170 (to generate the induced voltage due to the external magnetic field), and when the discharge to the magnet coil 170 is finished as described above, the magnetic energy of the magnet coil 170 allows the discharge current I′ to inversely flow into the pulse capacitor 150, to inversely charge the pulse capacitor 150. At the end point of one period of the damped oscillation sine wave, before the output switch 155 is switched off, the shunt switch 160 is switched on to lower the magnetic energy stored in the magnet coil 170 and the high voltage stored in the pulse capacitor 150 into the ground level. Even when the output switch 155 switched off, the burden of opening/closing surge, etc. is not applied to the output switch 155, so that the rated use of the switch is possible and it is also possible to avoid the electrical impact or deterioration of the magnet coil 170 and the pulse capacitor 150 due to the peak value due to the spike or the like in opening/closing the switch. Furthermore, since the apparatus for creating pulse magnetic stimulation according to the present invention comprises the shunt switch 160, it is possible to control the amplitude.

FIG. 3 is a circuit diagram illustrating a detailed configuration of the RLC serial resonant circuit of the apparatus for creating pulse magnetic stimulation according to the one preferred embodiment of the present invention.

Referring to FIG. 3, the capacitance C of the pulse capacitor 150, the inductance L of the magnet coil 170 and the internal resistance R of the magnet coil 170 itself correspond to the electrical parameters R, L, C of the basic RLC serial resonant circuit of the apparatus for creating pulse magnetic stimulation according to the present invention, respectively. Since the magnet coil 170 is formed as a single-layer solenoid and has the internal resistance, the magnet coil 170 includes L and R (see FIG. 4A).

The capacitance of the pulse capacitor 150 should be variable in order to variably obtain the pulse width of the period required for the under-damping oscillation of the RLC serial resonant circuit. Therefore, in order to vary the capacitance of the pulse capacitor 150, the pulse capacitor 150 may be constructed such that a plurality of pulse capacitors are connected in parallel. The additional pulse capacitors C2, C3, . . . , Cn other than a basic capacitor C1 can be connected in parallel to the basic capacitor C1 through the respective selection switches 210a, 210b, . . . , 210n (hereinafter, totally referred to as 210). In this case, the pulse capacitor 150 in the basic RLC serial resonant circuit selectively allows the capacitors C2, C3, . . . , Cn to be connected to the basic capacitor C1 using the selection switches 210. If the other capacitors other than the basic capacitor C1 are not connected at all (that is, if all the selection switches are switched off), the total capacitance is C1. On the other hand, if the pulse capacitors are all connected in parallel (that is, if all the selection switches are switched on), the total capacitance is a value obtained by summing the capacitances of the overall pulse capacitors connected in parallel (that is, C=C1+C2+ . . . +Cn [F]).

As described above, period of the damped oscillation sine wave usable in the apparatus for creating pulse magnetic stimulation according to the present invention is not limited.

Furthermore, from the period or the timing corresponding to the pulse width necessary for the damped oscillation sine wave, the time information of switching on/off the switch is determined.

Since the conditions for determining one period can be changed by changing the parameter C of the parameters R, L, C, the number of kinds of one period is determined correspondingly to the number of kinds of connections of the pulse capacitors connected in parallel. For example, if two pulse capacitors C2, C3 are connected to the basic pulse capacitor C1, the number of kinds of periods is 4.

The output switch 155 performs a function of blocking the current from flowing at the end point of one period of the damped oscillation since wave.

When the output switch 155 is switched on, the pulse capacitor 150 discharges the electric charge accumulated therein to the magnet coil 170, and thus a large current temporarily flows in the circuit. The large current is stored in the magnet coil 170 unless the output switch 155 is switched off, and when the discharge is finished, allows the electric charge to be re-accumulated in the pulse capacitor 150 in turn. The storage and discharge are repeated until the damped oscillation completely disappears. In this case, when the output switch 155 opens the large current circuit, the burden of opening/closing noise several tens times the large current flowing in lines is applied to the output switch 155. Therefore, in order to remove the burden applied to the output switch due to the large current, the shunt switch 160 is connected in parallel to the magnet coil 170.

FIG. 4A is a view illustrating an example of the magnet coil according to the one preferred embodiment of the present invention, FIG. 4B is a view illustrating a principle of focusing the magnetic flux, and FIG. 4C is a view exemplifying a configuration of the probe of the apparatus for creating pulse magnetic stimulation according to the one preferred embodiment of the present invention.

Referring to FIG. 4A, the magnet coil 170 of the probe of the apparatus for creating pulse magnetic stimulation according to the present invention can be constructed to have a single-layer solenoid shape.

In a closed loop having an area S within the magnetic flux, the induced voltage obtained from the following equation 1 is generated on the basis of Faraday's law.

$$e = - \frac{ⅆ ϕ}{ⅆ t} = {∮}_{c} E \cdot ⅆ 1 = - \frac{ⅆ}{ⅆ t} {∮}_{s} B \cdot ⅆ S [ V ] \qquad ( Equation 1 )$$

Here, e denotes the induced voltage, E denotes an electric field intensity and B denotes a flux density.

When the direction of the magnetic flux and the closed loop form a right angle, the induced voltage e can be obtained from the following equation 2.

$$e = S \frac{ⅆ}{ⅆ t} B ( t ) \qquad ( Equation 2 )$$

I the sectional area S of the detection coil and the induced voltage e as a designed target value are determined, the flux density B [Wb/m2] can be obtained from the equation 2, and it is also possible to obtain the storage voltage Vc of the pulse capacitor 150 of the RLC serial resonant circuit from the flux density, whereby the storage voltage thus generates the magnetic flux Φ[Wb] per unit area. Furthermore, when the storage voltage of the pulse capacitor 150 is calculated, the impedance can be calculated using the inductance and the resistance of the magnet coil 170, and thus the current value necessary for the RLC serial resonant circuit can be calculated.

By designing the magnet coil 170 of the apparatus for creating pulse magnetic stimulation according to the present invention as the single-layer solenoid, centers of the respective circular coils are placed on a central axis of the magnet coil 170 by Ampere's right-handed screw law. As seen from the target point, the individual magnetic flux is spaced from the origin point by the same distance, and as a result, the magnetic flux is added, so that it is possible to effectively generate the magnetic flux. Furthermore, the magnet coil 170 may be constructed as a multi-layer wiring solenoid, but since the resistance and inductance are increased due to the increase of the number of windings, the single-layer winding shape applies to the apparatus for creating pulse magnetic stimulation according to the present invention. Furthermore, in a case of application of the single-layer winding shape, there is an advantage that relatively low storage voltage can be used to obtain the induced voltage.

FIG. 4B is a view illustrating a principle of focusing the magnetic flux.

The magnet coil 170 formed in the single-layer solenoid type is surrounded with a protective member having a tennis racket shape and having an insulating feature for protecting the magnet coil 170. The protective member for the magnet coil 170 has air holes as many as possible to cool the generated heat in an air cooling manner, and is a mobile type.

When it is necessary to focus the magnetic flux on one point, a magnetic flux focusing unit can be added to the probe comprising the magnet coil 170 and the protective member for protecting the magnet coil 170.

As shown in FIG. 4B, the magnetic flux generated from the magnet coil 170 can be considered as a magnet starting from one end and returning to the other end, which are called the N pole and the S pole, respectively. That is, at a point in which the intensity of magnetic field is H [AT/m], magnetic lines of force pass through the sectional plane of the desired target perpendicular to the direction of magnetic field at a ratio of Hs per unit area [m²].

Supposed that the magnetic flux passes through an area S [m²] in the magnetic field, the magnetic flux per unit area Φ can be expressed as the following equation 3 together with the flux density B and the intensity of magnetic field H.
Φ=BS=μHS (Equation 3)

Therefore, the magnetic flux focusing unit for focusing the magnetic flux generated from the magnet coil 170 on a point uses the relationship of equation 3. On the other hand, the regulator having a feature of magnetic substance, as shown in FIG. 4B, is required for focusing the magnetic flux.

Further, the eddy current and the skin effect should be considered for effectively focusing the magnetic flux.

Since the magnetic flux has a feature of being focused on a side having large magnetic permeability, the magnetic flux focusing unit disposed in parallel to the magnet coil should be formed using material having very large magnetic permeability as a central magnetic substance and using material having less magnetic permeability with increase of a distance from the center of coil.

In order to reduce the eddy loss due to the skin effect and the eddy current, the magnetic flux focusing unit should have a stratiform iron core structure, and an end portion from which the magnetic flux is emitted should be formed to have a toy top shape. Since the magnetic flux focusing unit uses the iron core and thus Joule's heat may be generated, it is preferable that the magnetic flux focusing unit is sealed and a coolant (for example, cooling water, cooling oil, etc.) is injected therein.

A configuration of the magnetic flux focusing unit of the apparatus for creating pulse magnetic stimulation is exemplified in FIG. 4C. That is, the probe (magnetic flux emitting unit) is constructed by adding the magnetic flux focusing unit to the magnet coil 170 of the apparatus for creating pulse magnetic stimulation.

The operation principle of the magnetic flux focusing unit will be described hereunder.

A target is set apart from the magnet coil 170 by a desired distance (for example, less than 3 cm), and the magnetic flux focusing unit is positioned between the magnet coil 170 and the target.

When the magnetic flux Φ1 is emitted from the magnet coil 170, the magnetic flux is focused in accordance with the boundary condition of focusing the magnetic flux, and thus the magnetic flux Φ2 is emitted from the magnetic flux focusing unit. If the focused magnetic flux Φ2 has a circular diameter less than 2 mm, the magnetic flux focusing unit can be used as an electronic needle, and if the focused magnetic flux Φ2 has a circular diameter more or less than 10 mm, the magnetic flux focusing unit can be used as a local magnetic flux focusing unit. The boundary condition of focusing the magnetic flux means that components of the magnetic field parallel to the boundary surface are equal each other on both sides of the boundary surface and components of the magnetic field perpendicular to the flux density surface are equal each other on both sides of the boundary surface.

The magnetic flux focusing unit should be formed as thin as possible in the direction toward the target in order to prevent loss, and the regulator should be positioned on a side of the target opposite to the magnet coil 170 in order to facilitate the flux focusing. The regulator is formed as a pair for the purpose of convenience.

When a current flows in the magnet coil 170 to generate the magnetic flux, the induced voltage is generated in the target, and it is designed such that the induced voltage to be generated fall within a range of 5V to 15V.

Since the magnetic flux focusing unit is always used together with the magnet coil 170, it is preferable that they may be manufactured to be one body or to be attachable to each other, so that the magnetic flux focusing unit and the magnet coil 170 may be always coupled each other for use.

FIG. 5 is a view exemplifying a method of coupling an output monitor according to the one preferred embodiment of the present invention.

The output monitor (that is, the power monitor 175) serves for monitoring the disstorage current flowing in the magnet coil 170. The output (for example, charged or disstorage current) of the magnetic stimulation apparatus used as a medical instrument should be monitored in order to protect a patient.

As shown in FIG. 5, the output monitor of the apparatus for creating pulse magnetic stimulation according to the present invention is implanted in a non-contact type. That is, since the current flowing in the lines generates the magnetic flux in the vicinity thereof, the output monitor can detect the current flowing in the lines by detecting the magnetic flux.

By using the aforementioned method, since the current flowing through the shunt switch 160, the output switch 155, the pulse capacitor 150 and so on other than the current flowing through the magnet coil 170 can be also detected easily, detection of trouble points or diagnosis of apparatus can be considerably facilitated.

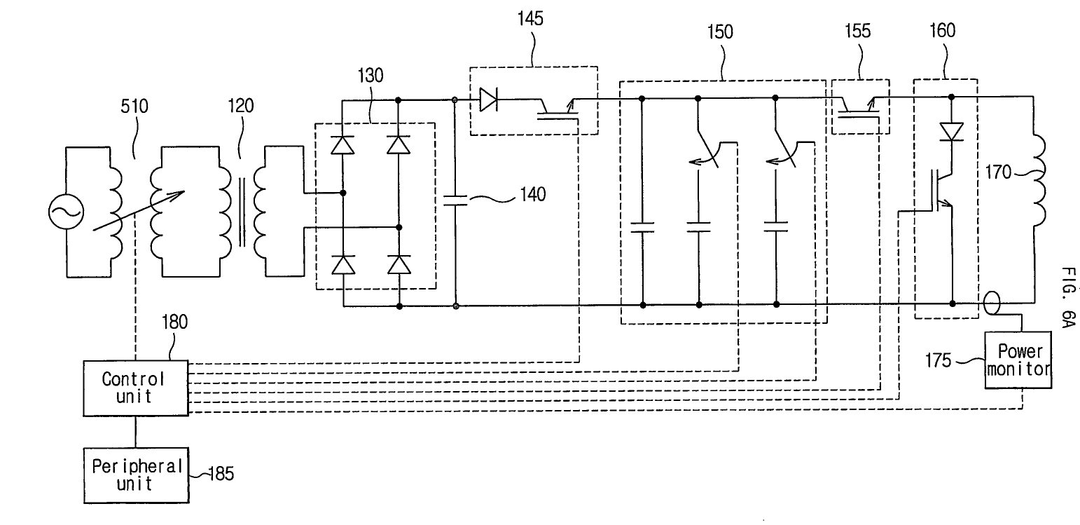

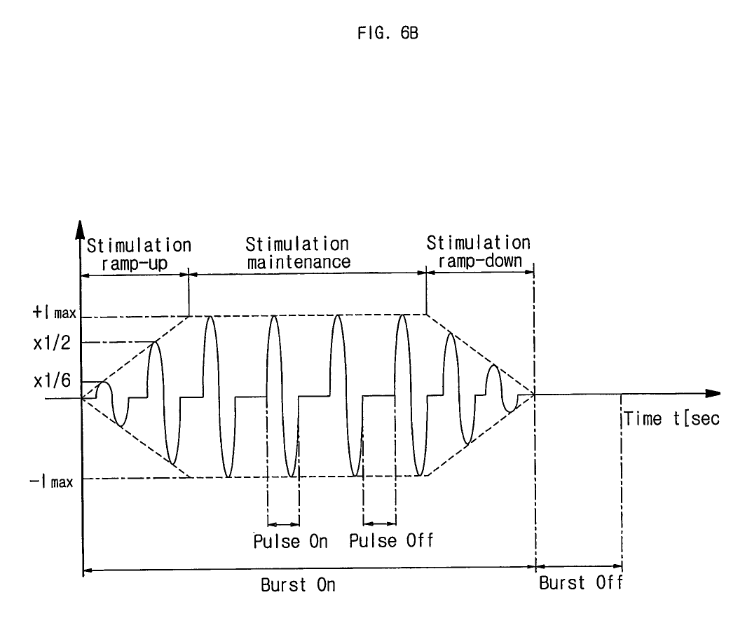

FIG. 6A is a circuit diagram illustrating in detail the apparatus for creating pulse magnetic stimulation according to the one preferred embodiment of the present invention, and FIG. 6B is a view illustrating an output modulation characteristic of the apparatus for creating pulse magnetic stimulation according to the one preferred embodiment of the present invention.

Supposed that the overall switches in the circuit diagram of the pulse-magnetic-stimulation creating apparatus shown in FIG. 6A are switched off, the operations of the circuit will be described.

When an external power source of 110V/220V, 50 Hz/60 Hz is input to the voltage input section 110, the output voltage is adjusted in the variable regulator 510 of the voltage input section 110, and then the output of the variable regulator 510 is input to the transformer 120. The output voltage of the variable regulator 510 can be controlled by the control unit 180, and the variable regulator 510 is used for controlling the amplitude after the reset timing of the shunt switch 160.

The AC voltage boosted through the transformer 120 is converted into the DC voltage through the full-wave rectification by the rectifier 130, and the converted DC voltage charges the pulse capacitor 150. Since the full-wave rectified DC voltage is a DC voltage not smoothed, it is converted into a relatively smoothed DC voltage by the filtering section 140 as a low pass filter. Then, when the input switch 145 is switched on, the DC voltage charges the pulse capacitor 150.

At that time, it is determined through selection of on/off of the selection switches 210 whether other pulse capacitors connected in parallel are charged or not. Therefore, by varying the C value, the frequency (period) of the damped oscillation can be varied.

When the charging is finished, the input switch 145 is switched off, and the on/off of the input switch can be controlled by the control unit 180. The charging time is determined in accordance with the supply ability of the filtering section 140 and the charge capacitance of the pulse capacitor 150.

When the charging of the pulse capacitor 150 is completed, the input switch 145 is switched off, and the output switch 155 is switched on. At the instant when the output switch is switched on, the storage voltage of the pulse capacitor 150 is applied to the magnet coil to allow a current to flow therein. When the current flows in the magnet coil 170, the external magnetic field is generated on the basis of Faraday's Law, a voltage is induced into an external conductor linking with the external magnetic field. However, when the magnetic flux links with a human body in place of the external conductor by using the apparatus for creating pulse magnetic stimulation according to the present invention, the eddy current is generated within the human body, and the induced voltage is induced from the eddy current, thereby creating stimulation.

One period after the output switch 155 is switched on and the current flows in the magnet coil 170, the shunt switch 160 is switched on. The electrical parameters of determining one period are values of R, L and C, and since the values of R and C are fixed in the present invention, the one period is varied in accordance with the value of C.

As soon as the shunt switch is switched on, the output switch 155 is switched off. By switching off the output switch after being lowered into the ground level, the one period is formed. As a result, it is possible to reduce the opening/closing burden of a high voltage and a large current and noises in the magnet coil, and it is also possible to sufficiently discharge the electric charge accumulated in the pulse capacitor 150 to allow the amplitude control.

As soon as the output switch 155 is switched off, the shunt switch 160 is switched off again. When the current supply to the magnet coil 170 is stopped, the magnetic energy and the induced voltage induced by the magnetic energy are extinguished, thereby resulting in inducing only one period of current.

The above procedure is a control procedure for forming one output pulse, and by repeating the above procedure as needed, various modulation modes required for the apparatus for creating pulse magnetic stimulation may be implemented.

The modulation modes which can be implemented in the apparatus for creating pulse magnetic stimulation according to the present invention include a ramp modulation, a phase modulation, a duration modulation, a timing modulation, an amplitude modulation, a frequency modulation and the like.

The ramp modulation is a modulation mode in which the first start portion and the last end portion in a burst configuration are increased or decreased step by step. According to this modulation mode, since the stimulation is started slowly, a patient can be protected from impact of sudden stimulation.

The phase modulation is a modulation mode in which the stimulation output is constructed such that one period is varied from 0, and it can be implemented by varying the pulse amplitude, the pulse width and the frequency constituting a burst. The phase modulation serves for delaying the current compliance of the human body.

The duration modulation is a modulation mode in which the phase time and the pulse time are varied variously within the burst on time. The duration modulation serves for effectively transferring energy for stimulation.

The timing modulation is a modulation mode in which a period of the burst is arbitrarily varied together with the period of pulses constituting the burst.

The amplitude modulation is a modulation mode in which the peak intensity is varied gradually or variously for the burst on time. The amplitude modulation serves for directly adjusting the intensity of stimulation.

The frequency modulation is a modulation mode in which the frequency is varied gradually or variously for the burst on time. In the apparatus for creating pulse magnetic stimulation according to the present invention, the resonance period of a next period is selected during the pulse off time, and the resonance period is determined in accordance with the value of C selected in the RLC serial resonant circuit. Therefore, pulses having various resonance periods can exist for the burst on time.

The apparatus for creating pulse magnetic stimulation according to the present invention has the parameter information on amplitude, frequency, pulse width, pulse duty, burst duty, timing and duration control, or the like.

An operational characteristic of the circuit shown in FIG. 6A to satisfy the respective modulation modes is shown in FIG. 6B.

The operational characteristic shown in FIG. 6B is relevant to a case that the maximum current flowing in the magnet coil 170 is 0 to 1200 A (the maximum voltage is 0 to 1200V) and at that time the induced voltage at a point spaced from the magnet coil by 1 cm is 1V per 100 A. A procedure for obtaining the operational characteristic shown in FIG. 6B will be described hereunder.

The variable regulator 510 controls the output thereof to set the current flowing in the magnet coil 170 to ⅙ times the maximum current. The variable regulator 510 is controlled by the control unit 180, and the control unit 180 is controlled by the user command inputted through the peripheral units 185.

The control unit 180 switches on the input switch 145 to accumulate the electric charge in the pulse capacitor 150. When the input switch 145 is switched off and the output switch 155 is switched on, the current corresponding to ⅙ times the maximum current is allowed to flow in the magnet coil and thus ⅙ times the maximum induced voltage is induced. Then, when the shunt switch 160 is switched off in a state that the output switch 155 is switched off, the initial state is restored.

After the aforementioned step is finished, the output of the variable regulator 510 is controlled to allow the current flowing in the magnet coil to be ½ times of the maximum current, and then the aforementioned step are repeated, thereby obtaining a waveform of one period for which a half of the maximum current flows.

The output of the variable regulator 510 is controlled to allow the maximum current to flow in the magnet coil, and then the aforementioned step are repeated, thereby obtaining a waveform of one period for which the maximum current flows.

The aforementioned three steps correspond to a stimulation ramp-up process. On the other hand, it is referred to as the amplitude modulation to vary the amplitude of the induced voltage by arbitrarily adjusting the magnitude of the current flowing in the magnet coil 170 using the variable regulator 510 of the voltage input section 110 as in the stimulation ramp-up process.

After the aforementioned process, the maximum current (that is, the maximum target current arbitrarily defined by a user) is maintained constantly unless the output of the variable regulator 510 or the parameter value (value of R, L or C) are varied, so that it is possible to maintain (plateau) the stimulation during a desired time.

After the stimulation maintenance, a stimulation ramp-down process is possible inversely to the stimulation ramp-up process, when the shunt switch 160 serves for removing (resetting) the voltage stored in the pulse capacitor 150. That is, after obtaining one period of the damped oscillation wave required by the user, the shunt switch 160 is switched on to connect the electric charge stored in the pulse capacitor 150 to the ground, thereby lowering the storage voltage of the pulse capacitor 150 to the ground level every time. Thereafter, it is determined by the variable regulator 510 how much the next voltage is stored.

The modulation of performing the stimulation ramp-up and the stimulation ramp-down is referred to as the ramp modulation. It is also possible to perform a continuous linear control of the stimulation ramp-up and the stimulation ramp-down.

The pulse on/off time repeated every constant time is referred to as a burst, and a time that the pulse on/off is repeated during the burst and the current flows in the magnet coil (that is, a time that the induced voltage is generated to create the stimulation) is referred to as a burst on. The stimulation ramp-up, the stimulation maintenance and the stimulation ramp-down all exist within the burst on time. On the contrary, a time that the stimulation ramp-up, the stimulation maintenance and the stimulation ramp-down do not exist at all is referred to as a burst off, and the burst on time to the total burst time is referred as a burst duty.

In the apparatus for creating pulse magnetic stimulation according to the present invention, the stimulation duration can be set to be variable, and a type of stimulation and a ratio of the burst intermittent times can be varied.

A cycle of the pulse on time and the pulse off time is referred to as a modulation period.

Although it is illustrated in the operational characteristic shown in FIG. 6B that the pulse on time and the pulse off time are matched with one period of the damped oscillation sine wave, the pulse off time can be determined variably through selection of a user. Since the pulse off time, not the pulse on time, is varied, the apparatus for creating pulse magnetic stimulation according to the present invention is different from the conventional electric stimulator in which the pulse on time (that is, pulse width) is linearly varied.

Up to now, paying attention to the damped oscillation sine wave under the under-damping condition in the RLC serial resonant circuit, operations of the apparatus for creating pulse magnetic stimulation according to the present invention is described.

A configuration and operational principle of the apparatus for creating pulse magnetic stimulation with a damped oscillation square wave, not the damped oscillation sine wave, will be described with reference to the relevant drawings.

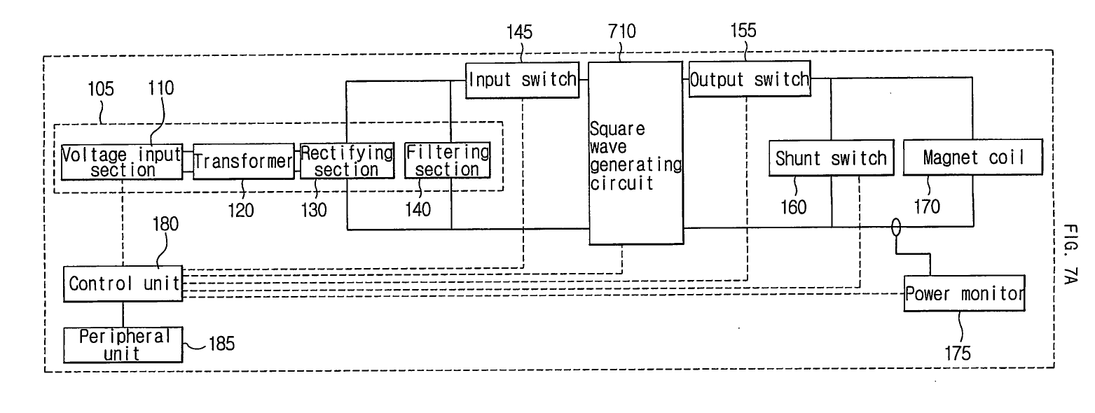

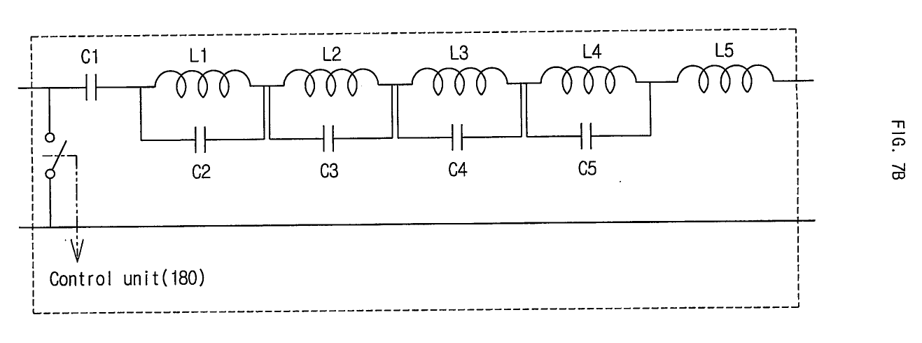

FIG. 7A is a block diagram of the apparatus for creating pulse magnetic stimulation according to another preferred embodiment of the present invention, and FIG. 7B is a circuit diagram illustrating in detail a square wave generating circuit according to the another preferred embodiment of the present invention.

The apparatus for creating pulse magnetic stimulation according to the another embodiment of the present invention shown in FIG. 7A is similar to the apparatus for creating pulse magnetic stimulation previously described with reference to FIG. 2A, except that a square wave generating circuit 710 for supplying a damped oscillation square wave resonant current is provided between the input switch 145 and the output switch 155 in place of the pulse capacitor 150.

In the square wave generating circuit 710, as shown in FIG. 7B, LC parallel resonant circuits by the number of harmonics desired are connected between one capacitor C1 and one inductor L5. Although it is shown in FIG. 7B that four parallel circuits of a capacitor and an inductor are connected in series, the number of the LC parallel resonant circuits can be determined variously as needed.

In signal transform methods performed in a high-voltage and large-current line, a signal transform method such as, for example, a method of transforming sine waves into square waves can be basically implemented by adding the respective order harmonics using the Fourier transform. For example, if using Guillemin's pulse-forming networks (PFNs), the signal transform in a high-voltage and large current line can be easily implemented.

Then, when the L value and the C value are selected in accordance with a desired resonance period and a current is allowed to flow in the magnet coil 170 similarly to the damped oscillation sine wave described above, the damped oscillation of square waves can be obtained. At that time, only one period desired is used and the others are switched off, which is similar to the damped oscillation sine wave.

The waveforms applicable to the apparatus for creating pulse magnetic stimulation according to the present invention can include a square wave, a triangular wave, etc. in addition to the damped oscillation sine wave.

Although it is described up to now that the input switch 145, the output switch 155 and the shunt switch 160 comprise only one, respectively, it is naturally possible to combine a plurality of switches in series or in parallel for use. When a plurality of switches are connected in series, the total switching voltage is obtained by summing the respective switching voltages.

Although it is described up to now only that the apparatus for creating pulse magnetic stimulation according to the present invention is used for the purpose of treating a human body, it is naturally possible to use the apparatus for the purpose of treating an animal in addition to a human body.

The present invention is not limited to the aforementioned embodiments, but it will be understood by those skilled in the art that various changes or modifications may be made thereto without departing from the spirit and scope of the present invention.

### INDUSTRIAL AVAILABILITY

In the apparatus and the method for creating pulse magnetic stimulation having a modulation function according to the present invention, it is possible to efficiently transfer energy on the basis of current compliance of a patient and impedance of biologic tissue according to the purposes of medical treatment.

Further, the present invention does not require separate means for storage into a high voltage or various auxiliary means such as a pumping coil or a current restriction coil when the magnetic stimulation apparatus is used for the purpose of medical treatment.

Furthermore, according to the present invention, since the shunt switch in the magnetic stimulation apparatus resets the storage voltage of the capacitor every timing modulation (that is, every time of switching on/off the switches) and thus the capacitor can be charged with the DC voltage supplied from the variable regulator within the maximum storage/discharged voltage, it is possible to perform the amplitude modulation.

Furthermore, according to the present invention, the variable regulator serves for reducing the opening/closing burden and noises in switching on/off the output switch, and in addition, since the shunt switch is short-circuited every timing modulation to serve for lowering the storage/discharging voltage into the ground level, thereby make the amplitude modulation possible.

Furthermore, the magnetic flux emitting unit according to the present invention can be a mobile type, not a fixed type, and can be incorporated into one body with or attachable to a magnetic flux focusing unit for focusing the magnetic flux generated from the coil.

What is claimed is:

1. An apparatus for creating pulse magnetic stimulation, in which pulse current is generated to create magnetic flux, the apparatus comprising:
a driving voltage supplying section for receiving AC voltage from a voltage source, converting the received AC voltage into DC voltage having a predetermined magnitude, and then outputting the DC voltage;
a capacitor section for accumulating electric charge in accordance with the DC voltage;
an input switch section provided between the driving voltage supplying section and the capacitor section, for controlling the accumulation of electric charge in the capacitor section;
a coil connected in series to the capacitor section, for generating magnetic flux in accordance with current generated by both-end voltage corresponding to the electric charge accumulated in the capacitor section;
an output switch section provided between the capacitor section and the coil, for controlling discharge of the electric charge accumulated in the capacitor section through the coil; and
a shunt switch section connected in parallel between the coil and the output switch section, for lowering magnetic energy stored in the coil and voltage stored in the capacitor section into a ground level to obtain a pulse magnetic field.

2. The apparatus for creating pulse magnetic stimulation according to claim 1, wherein said driving voltage supplying section comprises:
a variable regulator for converting the AC voltage supplied from the voltage source into an AC voltage specified by a control section;
a transformer for boosting the AC voltage outputted from the variable regulator into an AC voltage having a magnitude corresponding to a predetermined transformation ratio; and
a rectifying section for converting the AC voltage boosted by the transformer into the DC voltage.

3. The apparatus for creating pulse magnetic stimulation according to claim 2, wherein said driving voltage supplying section further comprises a filtering section for smoothing the DC voltage full-wave rectified by the rectifying section.

4. The apparatus for creating pulse magnetic stimulation according to claim 2, wherein said variable regulator can adjust a magnitude of the output AC voltage.

5. The apparatus for creating pulse magnetic stimulation according to claim 1, wherein when the magnetic energy and the voltage are lowered into the ground level in a state that the shunt switch section is switched on, the output switch section is switched off.

6. The apparatus for creating pulse magnetic stimulation according to claim 1, wherein when said electric charge has been completely accumulated in the capacitor section, the input switch section is switched off and the output switch section is switched on, and
wherein it is determined by means of capacitance of the capacitor section whether said electric charge has been completely accumulated in the capacitor section or not.

7. The apparatus for creating pulse magnetic stimulation according to claim 1, said apparatus further comprising a power monitoring section for calculating a magnitude of the current using the magnetic flux generated due to the current flowing through the coil to detect an error of a large power signal.

8. The apparatus for creating pulse magnetic stimulation according to claim 1, wherein said capacitor section is connected in parallel to an additional capacitor group, the additional capacitor group comprises one or more additional capacitor sections connected in parallel, respectively, and each of the additional capacitor sections comprises one additional capacitor and one switching element connected in series.

9. The apparatus for creating pulse magnetic stimulation according to claim 8, wherein on or off states of said switching element are controlled to change a value of capacitance, and only when the switching element is switched on, the capacitor section and the additional capacitor section are connected in parallel one another.

10. The apparatus for creating pulse magnetic stimulation according to claim 1 or 8, wherein when said input switch section and said shunt switch section are switched off and the output switch section is switched on, the capacitor section and the coil constitute an RLC serial resonant circuit, and each parameter value of the RLC serial resonant circuit satisfies an under-damping condition.

11. The apparatus for creating pulse magnetic stimulation according to claim 10, wherein said output switch section is switched on and off every one or a half period of the RLC serial resonant circuit, and a period in which said output switch section is switched on and off is less than 1 kHz.

12. The apparatus for creating pulse magnetic stimulation according to claim 1, wherein a waveform of the pulse current is at least one chosen from a sine wave, a square wave and a triangle wave.

13. The apparatus for creating pulse magnetic stimulation according to claim 1, wherein said input switch section, said output switch section and said shunt switch section are any one of a relay, a thyristor and an Insulated Gate Bipolar Transistor (IGBT).

14. An apparatus for creating pulse magnetic stimulation, in which pulse current is generated to create magnetic flux, the apparatus having a resonant circuit comprising a coil, a resistor and a capacitor, the apparatus further comprising:
a driving voltage supplying section connected in parallel to the capacitor, for accumulating electric charge in the capacitor, by receiving AC voltage from a voltage source, converting the received AC voltage into DC voltage having a predetermined magnitude, and then outputting the DC voltage;
an input switch section provided between the driving voltage supplying section and the capacitor, for allowing the electric charge to be accumulated in the capacitor only when the input switch section is switched on;
an output switch section provided between the capacitor and the coil, for allowing the electric charge accumulated in the capacitor to be discharged through the coil only when the output switch section is switched on; and
a shunt switch section connected in parallel between the coil and the output switch section, for lowering magnetic energy stored in the coil and voltage stored in the capacitor into a ground level to obtain a pulse magnetic field,
wherein the driving voltage supplying section comprises:
a variable regulator for converting the AC voltage supplied from the voltage source into an AC voltage specified by a control section;
a transformer for boosting the AC voltage outputted from the variable regulator into an AC voltage having a magnitude corresponding to a predetermined transformation ratio; and
a rectifying section for converting the AC voltage boosted by the transformer into the DC voltage.

15. The apparatus for creating pulse magnetic stimulation according to claim 14, wherein said capacitor is connected in parallel to an additional capacitor group, the additional capacitor group comprises one or more additional capacitor sections connected in parallel, respectively, and each of the additional capacitor sections comprises one additional capacitor and one switching element connected in series.

16. A method of supplying a pulse current to generate magnetic stimulation, comprising:
a step of inputting an operation start instruction to an apparatus for creating pulse magnetic stimulation;
(a) a step in which a power supplying section receives an AC voltage from a voltage source and converts the received AC voltage into an output AC voltage having a predetermined magnitude;
(b) a step in which a rectifying section converts the converted AC voltage into a DC voltage;
(c) a step in which when an input switch section is switched on, a capacitor section accumulates electric charge corresponding to the DC voltage;
(d) a step of switching off the input switch section and switching on an output switch section, when the capacitor section has completely accumulated the electric charge;
(e) a step of allowing a current to flow in a coil, the current being generated due to a both-end voltage corresponding to the electric charge accumulated in the capacitor section;
(f) a step in which the coil generates magnetic flux on the basis of the current;
(g) a step of switching on a shunt switch section after a predetermined period time;
(h) a step of switching off the output switch section and switching on the input switch section, when magnetic energy stored in the coil and voltage accumulated in the capacitor section is lowered into a ground level; and
a step of repeating the steps (a) to (h) until an operation end instruction is inputted to the apparatus for creating pulse magnetic stimulation, or a predetermined burst on period expires.

17. The method of supplying a pulse current according to claim 16, wherein after carrying out said steps (a) to (h), a step of determining a magnitude of voltage to be stored in the capacitor section is further carried out, and
wherein the magnitude of voltage to be stored in the capacitor section is determined on the basis of a magnitude of an output AC voltage converted by a variable regulator of the power supplying section.

18. The method of supplying a pulse current according to claim 16, wherein said steps (a) to (d) are carried out in a pulse off state where a current does not flow in the coil, and said steps (e) to (h) are carried out in a pulse on state where a current flows in the coil.

19. The method of supplying a pulse current according to claim 18, wherein the burst on period is a period that the pulse on state and the pulse off state are alternately repeated and thus, an induced voltage is generated to create a stimulation, and the burst on period comprises a stimulation ramp-up period, a stimulation maintenance period and a stimulation ramp-down period.

20. The method of supplying a pulse current according to claim 18, wherein the apparatus for creating pulse magnetic stimulation can vary a modulation period corresponding to a period of the pulse on time and the pulse off time by varying the pulse off time.

21. The method of supplying a pulse current according to claim 19, wherein during the stimulation ramp-up period, a magnitude of the output AC voltage converted by the variable regulator of the power supplying section becomes higher gradually, during the stimulation maintenance period, the magnitude of the output AC voltage of the power supplying section is maintained constantly, and during the stimulation ramp-down period, the magnitude of the output AC voltage converted by the variable regulator of the power supplying unit becomes lower gradually.

22. The method of supplying a pulse current according to claim 16, wherein the apparatus for creating pulse magnetic stimulation includes at least one of a ramp modulation, a phase modulation, a duration modulation, a timing modulation, an amplitude modulation, a frequency modulation, and a duty modulation.

23. The method of supplying a pulse current according to claim 22, wherein the apparatus for creating pulse magnetic stimulation includes at least one chosen from a ramp modulation, a phase modulation, a duration modulation, a timing modulation, an amplitude modulation, a frequency modulation and a duty modulation.

24. A magnetic flux emitting unit for externally emitting magnetic flux generated from a coil in a stimulation apparatus having a resonant circuit comprising the coil, a resistor and a capacitor, the apparatus generating a pulse current to create the magnetic flux, the unit comprising:
the coil;
a case having an insulating feature and also having a disk shape surrounding the coil;
a grip projected from a lower portion of the case; and
a lead line coupled to the coil and penetrating through the case and the grip,
wherein the coil is formed to be a single-layer solenoid shape, and the case has a plurality of air holes for cooling heat generated from the coil in an air cooling manner.

25. The magnetic flux emitting unit according to claim 24, further comprising a magnetic flux focusing unit coupled to the case, for focusing the magnetic flux generated from the coil on one point using a boundary condition of magnetic field,
wherein a coolant and a stratiform iron core of the magnetic flux focusing unit are sealed.

26. The magnetic flux emitting unit according to claim 25, wherein said stratiform iron core of the magnetic flux focusing unit is disposed in parallel to the coil, the permeability of materials of the central stratiform iron core is larger than the permeability of material of the peripheral stratiform iron core, an end portion of the stratiform iron core from which the magnetic flux is emitted is formed to have a toy top shape, and the coolant is circulated through a hose connected to the magnetic flux focusing unit.
